(19) United States
(12) Patent Application Publication
(10) Pub. No.: US 2024/0360877 A1
(43) Pub. Date: Oct. 31, 2024

(54) FRICTION PLATE HAVING A GROOVE PATTERN FORMED BY MEANS OF FRICTION LINING PADS

(71) Applicant: Schaeffler Technologies AG & Co. KG, Herzogenaurach (DE)

(72) Inventors: Alexander Bonet, Hersbruck (DE); Stefan Steinmetz, Essingen (DE); Christian Denda, Achern (DE); Benjamin Baerwald, Kuppenheim (DE)

(73) Assignee: Schaeffler Technologies AG & Co. KG, Herzogenaurach (DE)

(21) Appl. No.: 18/289,308

(22) PCT Filed: Apr. 1, 2022
(86) PCT No.: PCT/DE2022/100250

§ 371 Date: Nov. 2, 2023

(30) Foreign Application Priority Data
May 3, 2021 (DE) 10 2021 111 316.4
Jul. 8, 2021 (DE) 10 2021 117 620.4

(51) Int. Cl. F16D 13/64; F16D 69/00

(52) U.S. Cl. CPC F16D 13/648; F16D 2069/004

(57) ABSTRACT

A friction plate includes an annular groove pattern formed by first friction lining pads arranged between a radial outside and a radial center of the friction plate and second friction lining pads arranged between the radial center and a radial inside of the friction plate. The first friction lining have a triangular geometry at the radial outside and a rhomboid-shaped geometry at the radial center, and repeating in a circumferential direction. The second friction lining pads have a pentagonal geometry formed by a triangular geometry immediately adjacent to a rectangular geometry, and repeating in the circumferential direction. The annular groove pattern includes first segmentation grooves between respective ones of the first friction lining pads, second segmentation grooves between respective ones of the second friction lining pads, and a central segmentation groove separating the first friction lining pads from the second friction lining pads.

### CROSS-REFERENCE TO RELATED APPLICATIONS

This application is the United States National Phase of PCT Appln. No. PCT/DE2022/100250 filed Apr. 1, 2022, which claims priority to German Application Nos. DE102021111316.4 filed May 3, 2021 and DE102021117620.4 filed Jul. 8, 2021, the entire disclosures of which are incorporated by reference herein.

### TECHNICAL FIELD

The present disclosure relates to a groove pattern for friction plates.

### BACKGROUND

Grooves or groove patterns—also referred to as pad geometry in the context of this document—are used to cool the plates by means of an oil flow, even when the shifting elements are closed. They cut through the oil film and thereby stabilize the coefficient of friction. This creates the desired friction behavior when shifting. The idling behavior is improved and the drag torque is reduced.

Wet multi-plate clutches and brakes are widely used in conventional power-shiftable transmissions, in novel hybrid modules in heavy-duty drive trains or in shiftable e-axles, and they represent high-performance, heavy-duty components. The demands for lower CO2 emissions and improved efficiency of drive trains in automotive applications are of great importance. In addition to reducing load-independent losses in shifting elements, the thermal load and adequate cooling must be taken into account. The groove pattern of the friction plate plays a central role in the trade-off between friction characteristics, heat management, and efficiency. (see FIG. 1)

EP 3 354 921 A1 discloses annular, wet-running friction linings having grooves that connect an inner circumference and an outer circumference of the friction linings.

DE 10 2018 003 829 A1 discloses annular, wet-running friction linings with grooves that connect an inner circumference and an outer circumference of the friction linings, wherein the outer circumference of the friction linings has a course that deviates from a circular course.

### SUMMARY

The present disclosure minimizes the drag losses (cf. FIG. 2) and improves the cooling capacity in the case of friction plates by means of a suitable groove pattern.

The groove pattern for friction plates according to the present disclosure thus provides that the groove pattern is formed by means of first friction lining pads with a first pad geometry and second friction lining pads with a second pad geometry, and that the groove pattern results in a ring-shaped sequence of first pad geometries arranged to be radially external up to the center, and second pad geometries arranged to be radially internal repeating in the circumferential direction and spaced apart by segmentation grooves. The first and second pad geometry are separated from each other by a segmentation groove. The first pad geometry is designed as a combination of a triangular, radially externally arranged geometry with a rhomboid-shaped, radially centrally arranged pad geometry, and the second pad geometry is designed as a pentagonal geometry, designed as a combination of a triangular geometry with an immediately adjacent rectangular geometry.

In an example embodiment, the first pad geometry has an embossed groove.

In an example embodiment, the embossed groove is arranged between the triangular geometry arranged to be radially external and the rhomboid-shaped geometry arranged to be radially central. In this way, the drag torque is further reduced.

In a further exemplary embodiment of the groove pattern, the first friction lining pads in pad corners have pad angles of between five and one hundred and twenty-five degrees. Included in each pad corner is a pad interior angle.

In a further exemplary embodiment of the groove pattern, pad outer edges are rounded along the peripheral contour thereof at all pad corners of the first friction lining pads and the second friction lining pads. This has proven to be advantageous with regard to the flow around of the friction lining pad.

In another exemplary embodiment of the groove pattern, the rounding radii in the pad corners are greater than or equal to one millimeter. This has proven to be sufficient with regard to the flow around of the friction lining pads.

In another exemplary embodiment of the groove pattern, the first friction lining pads have widths and heights with a width-to-height ratio that is less than 1.5 for each first friction lining pad. The width-to-height ratio of the first friction lining pads is less than 1.1. This width-to-height ratio is advantageous for both directions of rotation in which the friction plates can be rotated.

In another exemplary embodiment of the groove pattern, the first and the second friction lining pads all have the same thickness. The thickness of the first friction lining pads is reduced only in the area of the embossed grooves.

In a further exemplary embodiment of the groove pattern, the embossed grooves have a smaller width than the segmentation grooves, and an embossing depth of the embossed grooves corresponds to a maximum of fifty percent of a thickness of the friction lining pads. As a result, the flow through the segmentation grooves and the embossed grooves can be influenced effectively.

In another exemplary embodiment of the groove pattern, the first and the second friction lining pads all represent a friction surface with an inner diameter and an outer diameter. All intersection points of the segmentation grooves with the embossed grooves and all intersection points of the segmentation grooves with segmentation grooves are arranged within the friction surface. The friction surface essentially has the shape of a circular ring area with an inner diameter and an outer diameter. The friction surface is delimited by the friction lining pads and, subject to tolerances, can have size deviations both on the inside diameter and on the outside diameter. The intersection points between the grooves are within the friction surface.

In another exemplary embodiment of the groove pattern, the embossed groove of the first friction lining pads intersects a segmentation groove defined by the triangular geometry of the respective first friction lining pad at an angle of between seventy-five and ninety degrees. An example degree measurement is 76.1 degrees. The specified angle range has proven to be effective with regard to a desired influencing of the oil flow in the claimed groove pattern.

In another exemplary embodiment of the groove pattern, segmentation grooves between the second friction lining pads have a greater groove width than segmentation grooves between the first friction lining pads. This is advantageous with regard to the cooling and/or lubricating function when the friction plates are in operation.

In another exemplary embodiment of the groove pattern, segmentation grooves between the second friction lining pads have a larger groove volume than segmentation grooves between the first friction lining pads. This is also advantageous with regard to the cooling and/or lubricating function during operation of the friction plates.

In a further exemplary embodiment of the groove pattern, the second friction lining pads have pad angles in pad corners of between sixty and one hundred and fifty degrees. In this way, the flow through the grooves can be specifically adjusted with simple means.

In another exemplary embodiment of the groove pattern, the second friction lining pads have widths and heights that have a width-to-height ratio that is less than one for each second friction lining pad. An example width-to-height ratio of the second friction lining pads is 0.93.

In another exemplary embodiment of the groove pattern, all friction lining pads have the same shape and size. This has proven to be advantageous with regard to the manufacture and assembly of the friction lining pads. The term same shape and size includes manufacturing tolerances.

The present disclosure also relates to a first and/or a second friction lining pad for a groove pattern as described above. The friction lining pads can be traded separately.

### BRIEF DESCRIPTION OF THE DRAWINGS

Further advantages and advantageous configurations of the present disclosure are the subject of the following figures and the description thereof. Specifically:

FIG. 1 shows relationships: air intake and drag torque;

FIG. 2 shows the object and improvements;

FIG. 3 shows groove design according to the invention, in particular Pad 1;

FIG. 4 shows the dimensioning of Pad 1 of the groove design according to the present disclosure;

FIG. 5 shows the dimensioning of Pad 1 of the groove design according to the present disclosure;

FIG. 6 shows the dimensioning of Pad 1 and Pad 2 of the groove design according to the present disclosure;

FIG. 7 shows the dimensioning of Pad 1 of the groove design according to the present disclosure;

FIG. 8 shows the groove design according to the present disclosure, in particular Pad 2;

FIG. 9 shows the dimensioning of Pad 2 of the groove design according to the present disclosure;

FIG. 10 shows the dimensioning of Pad 2 of the groove design according to the present disclosure;

FIG. 11 shows the dimensioning of the groove design according to the present disclosure; and

FIG. 12 shows a further groove design according to the present disclosure (mirrored).

### DETAILED DESCRIPTION

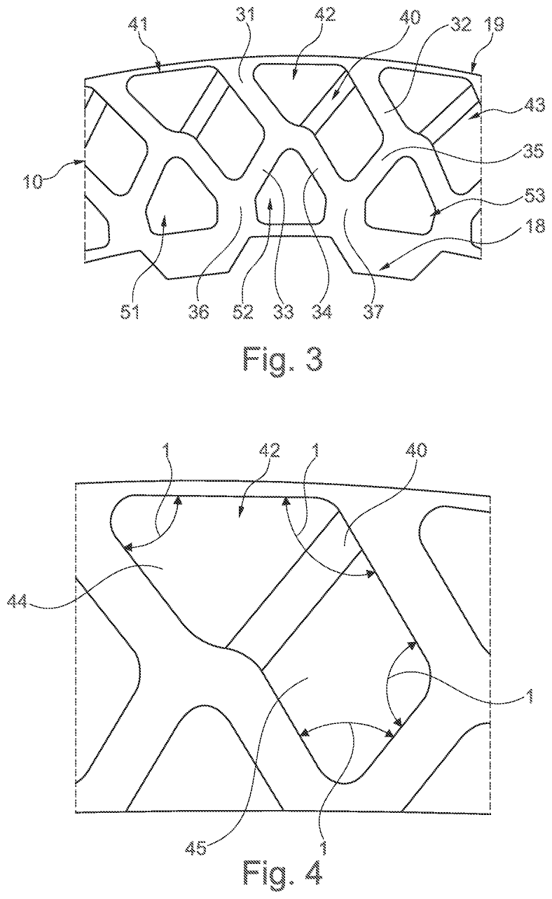

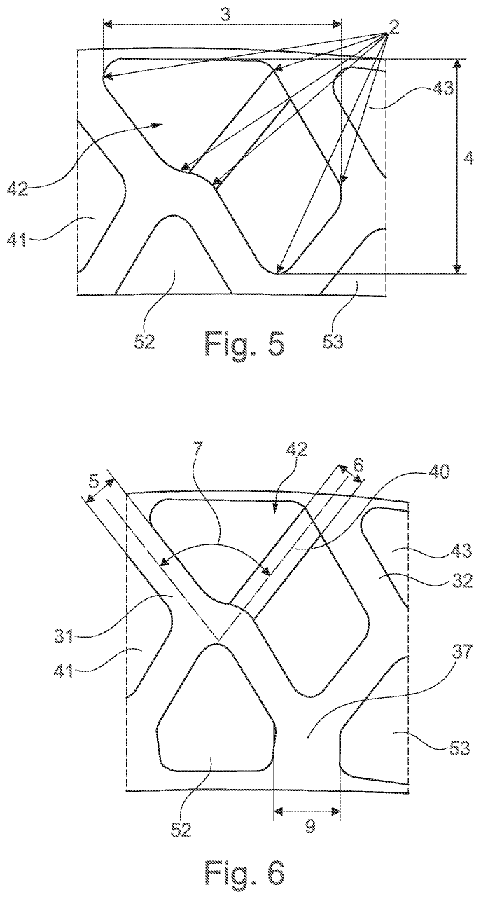

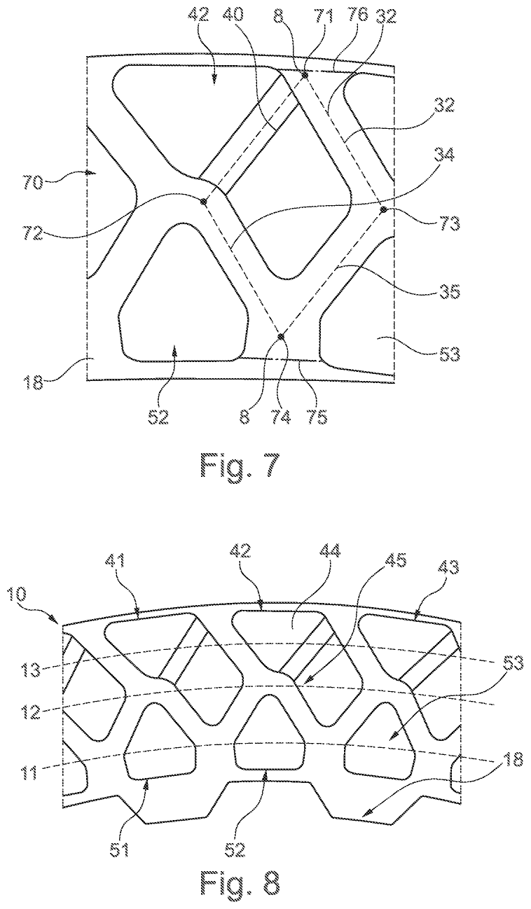

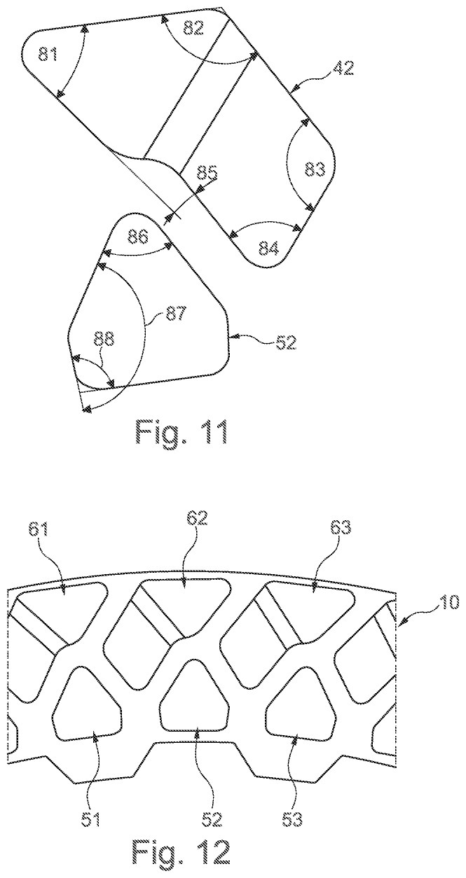

Pad 1 (FIG. 3-FIG. 7, FIG. 11, FIG. 12):
Pad angle (FIG. 4(1)) between 5 and 125 degrees (see FIG. 11 for details).
Pad outer edges rounded along the circumference, e.g., >=1 mm (FIG. 5 (2)).
Pad 1 design: Central embossing of the embossed groove (FIG. 6 (6)) results in a triangular pad surface radially externally and a square (rhomboid-shaped) pad surface radially centrally, each of which is unembossed.
Pad width (3)-to-height (4) ratio below 1.5 (e.g., 1.1) (FIG. 5).
Width of the embossed groove (FIG. 6 (6))<width of the segmentation groove (FIG. 6 (5), FIG. 11), i.e., the pad spacing between immediately adjacent pads 1 or between Pad 1 and Pad 2.
Maximum embossing depth is half of the lining thickness, i.e., at maximum half of the unembossed pad areas.
The angle (FIG. 6(7)) between the embossed groove (FIG. 6(6)) and the segmentation groove (FIG. 6(5)) is between 75 degrees and 90 degrees, e.g., 76.1 degrees.
Intersection point (FIG. 7 (8, top)) of embossed groove (FIG. 6 (6)) and segmentation groove (FIG. 6 (5)) within (smaller) the outer diameter (FIG. 7, dash-dotted line above). Intersection point (FIG. 7 (8, below)) of segmentation groove and segmentation groove between the rhomboid of the Pad 1 and the directly adjacent Pad 2 is a larger inner diameter (FIG. 7, dot-dash line below).
Groove volume of the entry groove (FIG. 6 (9))>groove volume of the exit groove (FIG. 6 (5))

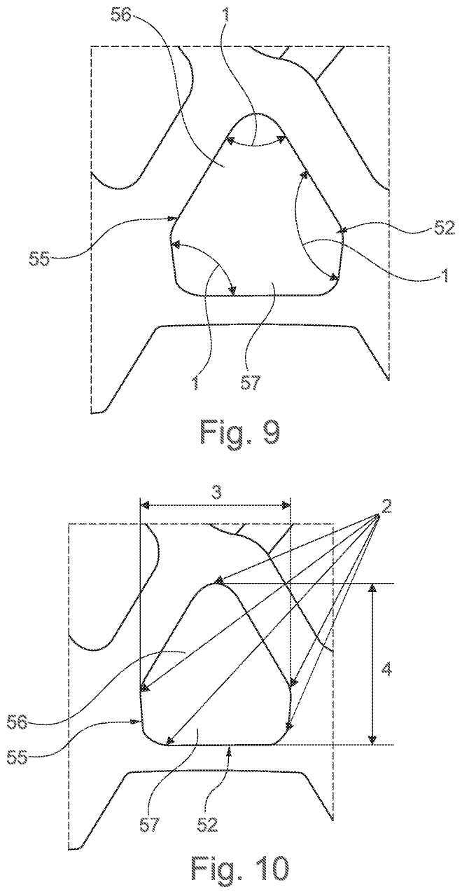

Pad 2 (FIG. 3, FIG. 6, FIG. 8-FIG. 11, FIG. 12):
Pad angle (FIG. 9 (1)) between 60 and 150 degrees (details see FIG. 11)
Pad outer edges rounded along the circumference, e.g., >=1 mm (FIG. 10 (2))
The basic geometry of the Pad 2 is implemented as a pentagonal geometry, which is implemented as a combination of a triangular geometry with an immediately adjacent rectangular geometry (FIG. 3, FIG. 6, FIGS. 8-11).
Pad width (3)-to-height (4) ratio less than 1 (e.g., 0.93) (FIG. 10)

Optimization of the production quality through optimized pad geometries.

Improvement of the fibrousness and the edge quality and thus reduction of the drag torques in the open state of the friction system (among other things, through the use of an embossed groove instead of a cut edge).

Robust wear behavior of the pad edges and pad corners over lifetime. Preservation of the edge geometry (low rounding (1)) leads to a robust, consistent hydrodynamic behavior (lubrication wedge) and thus to stable friction characteristics. Application effort of the control is reduced.

Optimization of the radial cooling capacity distribution: The groove volume decreases towards the outside (cf. groove inside (9) and groove outside (5) or embossing (6)), increasing the degree of filling of the groove (from inside to outside), thus improving the heat transfer from the steel plate to the oil.

FIG. 12 shows a further groove design according to the present disclosure. Compared to the previous representations, this results, for example, from mirroring at a radial line.

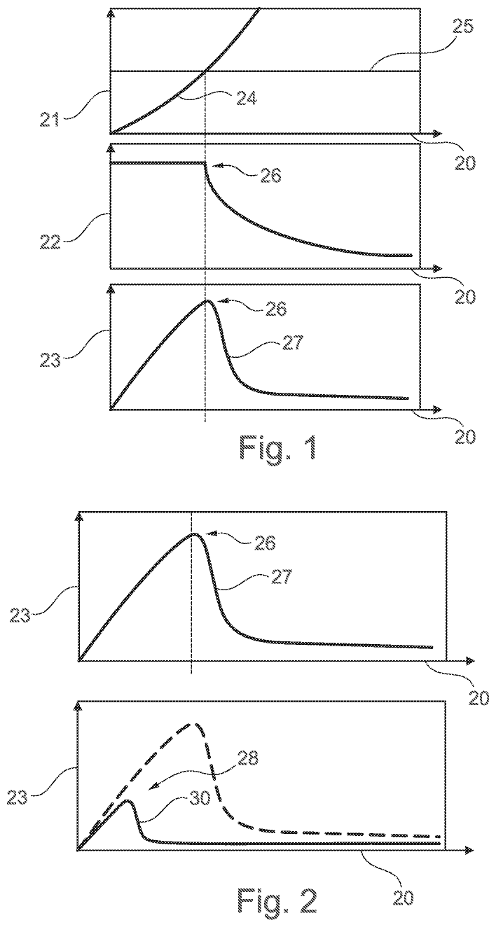

In FIG. 1, three Cartesian coordinate diagrams are shown one above the other. A rotation speed during operation of the wet-running multi-plate clutch with the friction part 15 in a suitable unit is plotted on an x-axis 20. A volume flow in a suitable unit is plotted on a y-axis 21. A gap fill level in a suitable unit is plotted on a y-axis 22. A drag torque is plotted in a suitable unit on a y-axis 23.

FIG. 1 illustrates how an air intake 26 is effected by a conveyed volume flow 24 if this exceeds the supplied volume flow 25. From this limit, the gap fill level 26 decreases and the lubricating gap between the plates contains air. Above this limit, a supplied volume flow 25 contains air. The bottom of FIG. 1 shows that the air intake 26 occurs at a maximum drag torque 27.

FIG. 2 shows how a displacement of the drawing-in of air 28 to a low rotation speed in a drag torque curve 30 is achieved with the claimed friction part 15. The conveying action of the cooling and/or lubricating medium can be improved by the groove pattern shown in FIG. 3.

A groove pattern 10, which is also referred to as a groove design, is shown in FIGS. 3 to 12. In FIGS. 3 to 12, the groove pattern 10 comprises first friction lining pads 41, 42, 43 and second friction lining pads 51, 52, 53.

The groove pattern 10 shown in FIG. 12 comprises the same first friction lining pads 51, 52, 53 as in FIG. 3. However, the groove pattern 10 in FIG. 12 comprises first friction lining pads 61, 62, 63, which are arranged in a mirror-inverted fashion compared to the first friction lining pads 41 to 43 in FIG. 3. Otherwise, the friction lining pads 61 to 63 correspond to the friction lining pads 41 to 43.

In FIG. 4, the friction lining pad 42 is shown enlarged. Like the other first friction lining pads 41 and 43, the friction lining pad 42 has a first pad geometry, which is composed of a triangular geometry 44 and a rhomboid-shaped geometry 45. An embossed groove 40 is formed in the first friction lining pad 42 between the triangular geometry 44 and the rhomboid-shaped geometry 45.

In FIG. 9, the second friction lining pad 52 is shown enlarged. Like the other second friction lining pads 51, 53, the second friction lining pad 52 has a second pad geometry, namely a pentagonal geometry 55, which is composed of a triangular geometry 56 and a rectangular geometry 57. A vertex of the triangular geometry 56 is directed radially externally.

In FIG. 3, one can see that the first friction lining pads 41 to 43 and the second friction lining pads 51 to 53 are glued onto a carrier plate 18 to represent a friction plate 19. The first friction lining pads 41 to 43 and the second friction lining pads 51 to 53 are arranged and spaced apart from one another in such a way that segmentation grooves 31 to 37 are formed, the depth of which is limited by the carrier plate 18.

In contrast to the segmentation grooves 31 to 37, the embossed groove 40 has a smaller depth. The depth of the embossed groove 40 is at most fifty percent of the thickness of the friction lining pad 42. The depth of the segmentation grooves 31 to 37 corresponds to the thickness of the friction lining pads 41 to 43; 51 to 53; 61 to 63.

Several plates 19 with steel plates are arranged in a plate pack in a plate clutch. Normally, when the multi-plate clutch is in operation, an assigned steel plate rotates faster than the respective friction plate.

Pad inner angles 1 of friction lining pads 42 and 52 are denoted in FIGS. 4 and 9. In FIG. 11, the pad inner angles 1 are provided with individual reference numbers 81 to 88.

The pad interior angle 81 is 51.2 degrees. The pad interior angle 82 is 121.3 degrees. The pad interior angle 83 is 110.8 degrees. The pad interior angle 84 is 69.2 degrees. The pad angle 85 is 7.5 degrees. The pad interior angle 86 is 61.7 degrees. The pad interior angle 87 is 145.4 degrees. The pad interior angle 88 is 93.8 degrees.

Using the example of friction lining pads 42 and 52, FIGS. 5 and 10 show that all first friction lining pads and all second friction lining pads have rounding radii 2. The rounding radii 2 are preferably greater than or equal to one millimeter.

In addition, a width 3 and a height 4 of the friction lining pads 42 and 52 are indicated in FIGS. 5 and 10 by double arrows. A corresponding width 3-to-height 4 ratio may be 1.1 for the first friction lining pads 41 to 43, and may be 0.93 for the second friction lining pads 51 to 53.

In FIG. 6, double arrows 5, 6 and 9 denote the widths of the segmentation groove 31, the embossed groove 40, and the segmentation groove 37. The segmentation groove 37 between the second friction lining pads 52 and 53 is open radially inwards and is therefore also referred to as an entry groove, through which oil enters during operation of the multi-plate clutch. Similarly, the radially outwardly open grooves 31 and 40 can also be referred to as exit grooves. The groove width 9 of the entry grooves 37 is greater than the groove width 5, 6 of the exit grooves 31, 40.

In addition, a branching angle 7 is indicated in FIG. 6 by a double arrow between the segmentation groove 31 and the embossed groove 40. The branching angle 7, which is also referred to as the embossing angle 7, may be 76. 1 degrees.

In FIG. 7, reference lines 75 and 76 indicate an inner diameter and an outer diameter of a friction surface 70, which is represented by the groove pattern 10 of the friction lining pads on the carrier plate 18. All intersection points 8; 71 to 74 of the grooves should lie within the friction surface 70.

The embossed groove 40 intersects with the segmentation groove 32 at the intersection point 71. At the intersection point 72, the embossed groove 40 intersects with the segmentation groove 34. The segmentation grooves 32 and 35 intersect at the intersection point 73. The segmentation grooves 34 and 35 intersect at the intersection point 74.

The intersection point 71 is located radially externally in the vicinity of the outer diameter 76, but still within the friction surface 70. Similarly, the intersection point 74 is located near the inner diameter 75, but also still within the friction surface 70.

In FIG. 8, three rows are indicated by dashed arcs 11, 12, 13, which are shown with the two pad geometries of the first friction lining pads 41 to 43 and the second friction lining pads 51 to 53. The second friction lining pads 51 to 53 represent a first row of a three-row groove pattern 10. The rhomboid-shaped geometries of the first friction lining pads 41 to 43 represent a second or central row of the three-row groove pattern 10. The triangular geometries of the first friction lining pads 41 to 43 represent a third row of the three-row groove pattern 10.

### REFERENCE NUMERALS

1 Pad inner angle
2 Curve radii
3 Width
4 Height
5 Groove width
6 Groove width
7 Branching angles
8 Intersection points
9 Groove width
10 Groove pattern
11 First row
12 Second row
13 Third row
18 Carrier plate
19 Friction plate
20 X-axis
21 Y-axis
22 Y-axis
23 Y-axis
24 Conveyed volume flow
25 Supplied volume flow
26 Air intake
27 Drag torque
28 Air intake
30 Drag torque curve
31 Segmentation groove
32 Segmentation groove
33 Segmentation groove
34 Segmentation groove
35 Segmentation groove
36 Segmentation groove
37 Segmentation groove
40 Embossed groove
41 First friction lining pad
42 First friction lining pad
43 First friction lining pad
44 Triangular geometry
51 Second friction lining pad
52 Second friction lining pad
53 Second friction lining pad
55 Pentagonal geometry
56 Triangular geometry
57 Rectangular geometry
61 First friction lining pad
62 First friction lining pad
63 First friction lining pad
70 Friction surface
71 First intersection point
72 Second intersection point
73 Third intersection point
74 Fourth intersection point
75 Inside diameter
76 Outside diameter
81 Angle
82 Angle
83 Angle
84 Angle
85 Angle
86 Angle
87 Angle
88 Angle

1. A groove pattern for friction plates, the groove pattern being formed by:
first friction lining pads with a first pad geometry; and
second friction lining pads with a second pad geometry; wherein:
the groove pattern is annular through a sequence of first pad geometries arranged radially externally up to a center and of second pad geometries arranged radially internally repeating in a circumferential direction and spaced apart from one another by segmentation grooves;
the first and second pad geometries being spaced apart from one another by a segmentation groove;
the first pad geometry is designed as a combination of a triangular geometry arranged radially externally and a rhomboid-shaped geometry arranged radially centrally; and
the second pad geometry is embodied as a pentagonal geometry which is embodied as a combination of a triangular geometry with an immediately adjacent rectangular geometry.

2. The groove pattern according to claim 1, wherein the first pad geometry has an embossed groove.

3. The groove pattern according to claim 2, wherein the embossed groove is arranged between the triangular, radially externally arranged geometry and the rhomboid-shaped, radially centrally arranged geometry.

4. The groove pattern according to claim 1, wherein the first friction lining pads have in pad corners pad angles of between 5 and 125 degrees.

5. The groove pattern according to claim 1, wherein the first friction lining pads have widths and heights which have a width-to-height ratio for each first friction lining pad which is less than 1.5.

6. The groove pattern according claim 1, wherein:
the first and the second friction lining pads represent a friction surface with an inner diameter and an outer diameter; and
both all intersection points of the segmentation grooves with the embossed grooves and all intersection points of the segmentation grooves with segmentation grooves are arranged within the friction surface.

7. The groove pattern according to claim 1, wherein the embossed groove of the first friction lining pads intersects with a segmentation groove bounded by the triangular geometry of the respective first friction lining pad at an angle of between 75 and 90 degrees.

8. The groove pattern according to claim 1, wherein segmentation grooves between the second friction lining pads have a greater groove width than segmentation grooves between the first friction lining pads.

9. The groove pattern according to claim 1, wherein the second friction lining pads have in pad corners pad angles at an angle of between 60 and 150 degrees.

10. The groove pattern according to claim 1, wherein the second friction lining pads have widths and heights which have a width-to-height ratio which for each second friction lining pad is less than one.

11. A friction plate comprising an annular groove pattern, the annular groove pattern being formed by:
first friction lining pads arranged between a radial outside and a radial center of the friction plate, the first friction lining pads:
comprising a triangular geometry at the radial outside and a rhomboid-shaped geometry at the radial center; and
repeating in a circumferential direction; and
second friction lining pads arranged between the radial center and a radial inside of the friction plate, the second friction lining pads:
comprising a pentagonal geometry formed by a triangular geometry immediately adjacent to a rectangular geometry; and
repeating in the circumferential direction, wherein the annular groove pattern comprises:
first segmentation grooves between respective ones of the first friction lining pads;
second segmentation grooves between respective ones of the second friction lining pads; and
a central segmentation groove separating the first friction lining pads from the second friction lining pads.

12. The friction plate of claim 11, wherein the first friction lining pads comprise respective embossed grooves.

13. The friction plate of claim 12, wherein each respective embossed groove is arranged between the triangular geometry and the rhomboid-shaped geometry.

14. The friction plate of claim 11, wherein the first friction lining pads comprise respective corner angles between 5 and 125 degrees.

15. The friction plate of claim 11, wherein the first friction lining pads each comprise a circumferential width to radial height ratio that is less than 1.5.

16. The friction plate of claim 11 wherein a width of the second segmentation grooves is greater than a width of the first segmentation grooves.

17. The friction plate of claim 11, wherein the second friction lining pads comprise respective corner angles between 60 and 150 degrees.

18. The friction plate of claim 11, wherein the second friction lining pads each comprise a circumferential width to radial height ratio that is less than 1.
